(19) United States
(12) Patent Application Publication
(10) Pub. No.: US 2012/0013620 A1
(43) Pub. Date: Jan. 19, 2012

(54) Animating Speech Of An Avatar Representing A Participant In A Mobile Communications With Background Media

(75) Inventors: William A. Brown, Raleigh, NC (US); Richard W. Muirhead, Tyler, TX (US); Francis X. Reddington, Sarasota, FL (US); Martin A. Wolfe, Mooresville, NC (US)

(73) Assignee: INTERNATIONAL BUSINESS MACHINES CORPORATION, Armonk, NY (US)

(21) Appl. No.: 12/834,945

(22) Filed: Jul. 13, 2010

(51) Int. Cl. G06T 15/70

(52) U.S. Cl. 345/473

(57) ABSTRACT

Animating speech of an avatar representing a participant in a mobile communication including preparing the avatar for display for display including: selecting images to represent the participant, selecting a generic animation template having a mouth, fitting the images with the generic animation template, and texture wrapping the one or more images representing the participant over the generic animation template; selecting background media; displaying images texture wrapped over the generic animation template with the background media; and animating the images including: receiving an audio speech signal, identifying a series of phonemes, and for each phoneme: identifying a next mouth position, altering the mouth position, texture wrapping a portion of the images corresponding to the altered mouth position, displaying the texture wrapped portion and playing, synchronously with the displayed texture wrapped portion, the portion of the audio speech signal represented by the phoneme.

### BACKGROUND OF THE INVENTION

1. Field of the Invention

The field of the invention is data processing, or, more specifically, methods, apparatus, and products for animating speech of an avatar representing a participant in a mobile communication.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Typical computer systems may be implemented in many devices, including, for example cellular phones. Although computer systems implemented in cellular phones are powerful, networks connecting cellular phones create a bottleneck for communications. Real-time video conferencing between cellular phones across a network, for example, is difficult to implement due to the large amount of bandwidth required for transmission of audio and video data corresponding to a real-time video and audio feed. Today there exists no low-bandwidth, or lightweight, method of displaying a representation of a cellular phone user across a network.

### SUMMARY OF THE INVENTION

Methods, mobile communications devices, and products for animating speech of an avatar representing a participant in a mobile communication are disclosed. Embodiments of the present invention include preparing for display, by the mobile communications device, the avatar including: selecting, from data storage, one or more images to represent the participant, selecting, from data storage, a generic animation template for the participant, the generic animation template having a mouth, the mouth characterized by a mouth position, fitting the one or more images representing the participant with the generic animation template, and texture wrapping the one or more images representing the participant over the generic animation template. Embodiments of the present invention also include selecting, by the mobile communications device from storage, background media as a background to the one or more images texture wrapped over the generic animation template and displaying, by the mobile communications device, the one or more images texture wrapped over the generic animation template with the background media as the background to the one or more images texture wrapped over the generic animation template.

Embodiments of the present invention also include animating, by the mobile communications device, the one or more images texture wrapped over the generic animation template including: receiving an audio speech signal derived from the mobile communication of the participant, identifying, from the audio speech signal, a series of phonemes, each phoneme representing a portion of the audio speech signal, and for each phoneme: identifying a next mouth position for the mouth of the generic animation template, altering the mouth position of the mouth of the generic animation template to the next mouth position, texture wrapping a portion of the one or more images corresponding to the altered mouth position of the mouth of the generic animation template, displaying the texture wrapped portion of the one or more images corresponding to the altered mouth position of the mouth of the generic animation template and playing, synchronously with the displayed texture wrapped portion of the one or more images, the portion of the audio speech signal represented by the phoneme.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of a system for animating speech of an avatar representing a participant in a mobile communication according to embodiments of the present invention.

FIG. 2 sets forth a portion of a flow chart illustrating an exemplary method for animating speech of an avatar representing a participant in a mobile communication according to embodiments of the present invention.

FIG. 3 sets forth a further portion of a flow chart illustrating an exemplary method for animating speech of an avatar representing a participant in a mobile communication according to embodiments of the present invention.

FIG. 4 sets forth a flow chart illustrating an exemplary method for selecting background media as a background to the one or more images texture wrapped over the generic animation template when animating speech of an avatar representing a participant in a mobile communication according to embodiments of the present invention.

### DETAILED DESCRIPTION OF EXEMPLARY EMBODIMENTS

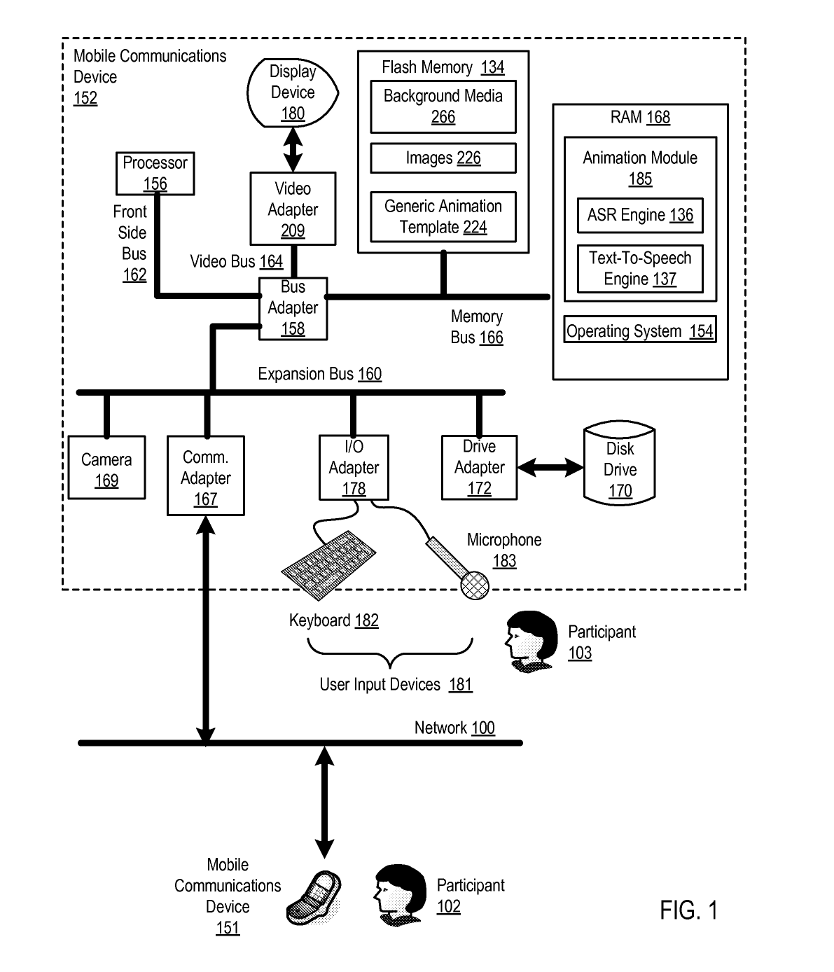

Exemplary methods, apparatus, and products for animating speech of an avatar representing a participant in a mobile communication in accordance with the present invention are described with reference to the accompanying drawings, beginning with FIG. 1. FIG. 1 sets forth a functional block diagram of a system for animating speech of an avatar representing a participant in a mobile communication according to embodiments of the present invention. An avatar is a graphical representation of a participant in a mobile communication. Avatars are typically two or three dimensional representations. Avatars useful in embodiments of the present invention, for example, may be implemented as a three dimensional model that represents the participant.

Mobile communications are any communications between mobile communications devices. Types of mobile communications may include voice communications between participants, Short Message Service (‘SMS’) text messages, Multimedia Messaging Service (‘MMS’) messages, email, or others as will occur to those of skill in the art. The mobile communications device of FIG. 1 includes several user input devices (181) that a participant (103) may use to communicate through the mobile communications device (152). The mobile communications device of FIG. 1 for example, includes a keyboard (182) and a microphone (183).

In the system of FIG. 1 the participant (102) uses a mobile communications device for mobile communications with another participant (103) using another mobile communications device (152). A mobile communications device (152) may be implemented as a cellular phone, a smart phone, a tablet computing device with a Voice Over Internet Protocol (‘VOIP’) application, or other device as will occur to those of skill in the art. A cellular phone is a long-range, portable electronic device used for mobile communication. In addition to the standard voice function of a telephone, current cellular phones may support many additional services such as SMS, MMS, email, and internet access. A smart phone is typically implemented as a full-feature cellular phone with personal computer functionality. Many smart phones are cellular phones that support full featured email capabilities with the functionality of a complete personal organizer A common feature of many smart phones is that applications for enhanced data processing and connectivity are capable of being installed on the device, in contrast to non-smart cellular phones which typically only support sandboxed applications. The applications that may be installed on a smart phone may be developed by the manufacturer of the device, by the operator of the device, or by any other third-party software developer. Also in contrast to non-smart cellular phones, smart phones typically include interfaces including a miniature ‘QWERTY’ keyboard, a touch screen, or secure access to company email services.

The system of FIG. 1 includes an exemplary mobile communications device (152) useful in animating speech of an avatar representing a participant in a mobile communication according to embodiments of the present invention. The mobile communications device (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an animation module (185), a module of computer program instructions for animating speech of an avatar representing a participant in a mobile communication according to embodiments of the present invention. The exemplary animation module (185) of FIG. 1 is capable of preparing the avatar for display including: selecting, from data storage, one or more images (226) to represent the participant (102); selecting, from data storage, a generic animation template (224) for the participant; fitting the one or more images (226) representing the participant (102) with the generic animation template (224); and texture wrapping the one or more images (226) representing the participant (102) over the generic animation template (224). Data storage in a mobile communications device may be implemented in various forms. In the mobile communications device (152) of FIG. 1, for example, data storage may be implemented as flash memory (134) or as a disk drive (170). Many typical mobile communications devices include non-removable as well as removable flash memory. Removable flash memory may be implemented as any type of memory card including, for example, a Secure Digital (‘SD’) memory card, a Multimedia Card (‘MMC’), a Memory Stick, a Compact Flash (‘CF’) memory card, a SmartMedia (‘SM’) card, and so on as will occur to those of skill in the art. Flash memory data storage useful in animating speech of an avatar representing a participant in a mobile communication according to embodiments of the present invention may be implemented as either the removable or non-removable type of flash memory.

The example animation module (185) of FIG. 1 is also capable of selecting background media (266) as a background to the one or more images (226) texture wrapped over the generic animation template (224). The term ‘background media’ refers to any media that may be displayed behind an avatar, including for example a digital image, a digital video, an animated graphic, and the like. That is, the background displayed behind an avatar animated in accordance with embodiments of the present invention may be a static image or dynamic video stream.

The example animation module (185) of FIG. 1 is also capable of displaying, by the animation module, the one or more images (226) texture wrapped over the generic animation template (224) with the background media (266) as the background to the one or more images (226) texture wrapped over the generic animation template (224). The background media and texture wrapped animation template (224) may be displayed in two separate layers. That is, the texture wrapped animation template may be a first layer independent of the background media, a second layer. In this way, background media may be dynamically changed in lightweight manner, without the need to modify the texture wrapped animation template, and vice versa.

The animation module (185) of FIG. 1 is also capable of animating, by the animation module, the one or more images texture wrapped over the generic animation template including: receiving an audio speech signal derived from the mobile communication of the participant and identifying, from the audio speech signal, a series of phonemes, each phoneme representing a portion of the audio speech signal. For each identified phoneme, the animation module (185) of FIG. 1 is capable of identifying a next, or said another way a ‘new,’ mouth position for the mouth of the generic animation template (224); altering the mouth position of the mouth of the generic animation template (224) to the new mouth position; texture wrapping a portion of the one or more images (226) corresponding to the altered mouth position of the mouth of the generic animation template (224); displaying the texture wrapped portion of the one or more images (226) corresponding to the altered mouth position of the mouth of the generic animation template (224); and playing, synchronously with the displayed texture wrapped portion of the one or more images (226), the portion of the audio speech signal represented by the phoneme.

The animation module (185) of FIG. 1 may receive an audio speech signal derived from the mobile communication of the participant (102) by receiving text from the participant's mobile communications device and converting the text to synthesized speech or, in the alternative, receiving audio from the participant's mobile communications device. The animation module (185) of FIG. 1 may convert text to speech with a speech engine. Stored in RAM (168) of the mobile communications device of FIG. 1 is, for example, a text-to-speech engine (137). A text-to-speech engine (137) is a module of computer program instructions capable of converting text to an audio speech signal. Although the text-to-speech engine (137) in the example of FIG. 1 is shown as part of the animation module (185) for clarity, readers of skill in art will immediately recognize that a text-to-speech engine useful in animating speech of an avatar representing a participant in a mobile communication according to embodiments of the present invention may be an independent module of computer program instructions. Examples of speech engines capable of converting text to speech for recording in the audio portion of a multimedia file include, for example, IBM's ViaVoice® Text-to-Speech, Acapela Multimedia TTS, AT&T Natural Voices™ Text-to-Speech Engine, and Python's pyTTS class. Each of these text-to-speech engines is composed of a front end that takes input in the form of text and outputs a symbolic linguistic representation to a back end that outputs the received symbolic linguistic representation as a speech waveform.

Typically, speech synthesis engines operate by using one or more of the following categories of speech synthesis: articulatory synthesis, formant synthesis, and concatenative synthesis. Articulatory synthesis uses computational biomechanical models of speech production, such as models for the glottis and the moving vocal tract. Typically, an articulatory synthesizer is controlled by simulated representations of muscle actions of the human articulators, such as the tongue, the lips, and the glottis. Computational biomechanical models of speech production solve time-dependent, 3-dimensional differential equations to compute the synthetic speech output. Typically, articulatory synthesis has very high computational requirements, and has lower results in terms of natural-sounding fluent speech than the other two methods discussed below.

Formant synthesis uses a set of rules for controlling a highly simplified source-filter model that assumes that the glottal source is completely independent from a filter which represents the vocal tract. The filter that represents the vocal tract is determined by control parameters such as formant frequencies and bandwidths. Each formant is associated with a particular resonance, or peak in the filter characteristic, of the vocal tract. The glottal source generates either stylized glottal pulses or periodic sounds and generates noise for aspiration. Formant synthesis generates highly intelligible, but not completely natural sounding speech. However, formant synthesis has a low memory footprint and only moderate computational requirements.

Concatenative synthesis uses actual snippets of recorded speech that are cut from recordings and stored in an inventory or voice database, either as waveforms or as encoded speech. These snippets make up the elementary speech segments such as, for example, phones and diphones. Phones are composed of a vowel or a consonant, whereas diphones are composed of phone-to-phone transitions that encompass the second half of one phone plus the first half of the next phone. Some concatenative synthesizers use so-called demi-syllables, in effect applying the diphone method to the time scale of syllables. Concatenative synthesis then strings together, or concatenates, elementary speech segments selected from the voice database, and, after optional decoding, outputs the resulting speech signal. Because concatenative systems use snippets of recorded speech, they have the highest potential for sounding like natural speech, but concatenative systems require large amounts of database storage for the voice database.

The animation module (185) of FIG. 1 may identify from the audio speech signal a series of phonemes by using an automatic speech recognition (‘ASR’) engine. A phoneme is the smallest unit of speech that distinguishes meaning Phonemes are not phonetic segments themselves, but are abstractions of phonetic segments. An example of a phoneme would be the /t/ found in words like tip, stand, writer, and cat.

An ASR engine (136) is a module of computer program instructions, also stored in RAM (168) in this example. Like the text-to-speech engine (137), the ASR engine (136) is shown in FIG. 1 for clarity as part of the animation module (185). Readers of skill in the art, however, will immediately recognize that such ASR engine may be an independent module of computer program instructions. In carrying out automated speech recognition, the ASR engine (136) receives speech for recognition in the form of at least one digitized word and uses frequency components of the digitized word to derive a Speech Feature Vector (‘SFV’). An SFV may be defined, for example, by the first twelve or thirteen Fourier or frequency domain components of a sample of digitized speech. The ASR engine can use the SFV to identify phonemes for the word from a language-specific acoustic model, a mapping of SFVs and phonemes.

The mobile communications device (152) of FIG. 1 also includes a camera (169) for capturing digital images. The camera (169) of FIG. 1 may be used for capturing one or more digital images of the participant (102) and storing the captured digital images for use as the one or more images (226) to represent the participant (102). That is, the one or more images (226) used in animating an avatar representing the participant (102) may be actual images of the participant captured by the camera (169) at a time before the animation of the avatar. In the alternative to capturing the digital images of the participant, the images (226) stored in flash memory (134) may be preconfigured by the manufacturer of the mobile communications device (152). That is, the manufacturer of the mobile communications device (152) may provide default images that can be used in animating an avatar of a participant of a mobile communication. A manufacturer may for example provide default male or female images.

Also stored in RAM (168) is an operating system (154). Operating systems useful animating speech of an avatar representing a participant in a mobile communication according to embodiments of the present invention include UNIX®, Linux®, Microsoft® XP, Microsoft® Vista, IBM® AIX®, IBM i5/OS®, and others as will occur to those of skill in the art. UNIX is a registered trademark of The Open Group in the United States and other countries. Linux is a registered trademark of Linus Torvalds in the United States, other countries, or both. Microsoft is a trademark of Microsoft Corporation in the United States, other countries, or both. IBM, AIX, and i5/OS are trademarks of International Business Machines Corporation in the United States, other countries, or both. The operating system (154), animation module (185), text-to-speech engine (137), and ASR engine (136) in the example of FIG. 1 are shown in RAM (168), but many components of such software typically are stored in non-volatile memory also, such as, for example, on a disk drive (170).

The mobile communications device (152) of FIG. 1 includes disk drive adapter (172) coupled through expansion bus (160) and bus adapter (158) to processor (156) and other components of the mobile communications device (152). Disk drive adapter (172) connects non-volatile data storage to the mobile communications device (152) in the form of disk drive (170). Disk drive adapters useful in mobile communications devices for animating speech of an avatar representing a participant in a mobile communication according to embodiments of the present invention include Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example mobile communications device (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. In the example of FIG. 1 the mobile communications device includes two exemplary user input devices (181), a keyboard (182) and a microphone (183). The participant (103) may use the keyboard to compose SMS test messages and email, among other things, and the participant may use to the microphone to capture audio speech signals of the participant during a mobile communication.

The example mobile communications device (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary mobile communications device (152) of FIG. 1 includes a communications adapter (167) for data communications with other mobile communications device (151) and for mobile communications with a network (100). The network (100) is shown for clarity as a single network, but readers of skill in the art will immediately recognize that such a network (100) may actually be implemented as a combination of several networks, a network for voice calls as a well as a separate data communications network for example. A network implemented for voice calls may be a Time Division Multiple Access (‘TDMA’) network, a Global System for Mobile communications (‘GSM’) network, a Code Division Multiple Access (‘CDMA’), and so on as will occur to those of skill in the art. A network implemented for data communications, including SMS text messages, email, internet traffic, and MMS messages, may be an Enhanced Data Rate for GSM Evolution (‘EDGE’) network, Wideband Code Division Multiple Access (‘W-CDMA’) network, a High-Speed Downlink Packet Access (‘HSDPA’) network, and so on as will occur to those of skill in the art.

The arrangement of mobile communications devices making up the exemplary system illustrated in FIG. 1 are for explanation, not for limitation. Mobile communication systems useful according to various embodiments of the present invention may include additional computers, servers, routers, other devices not shown in FIG. 1, as will occur to those of skill in the art. Networks in such mobile communication systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

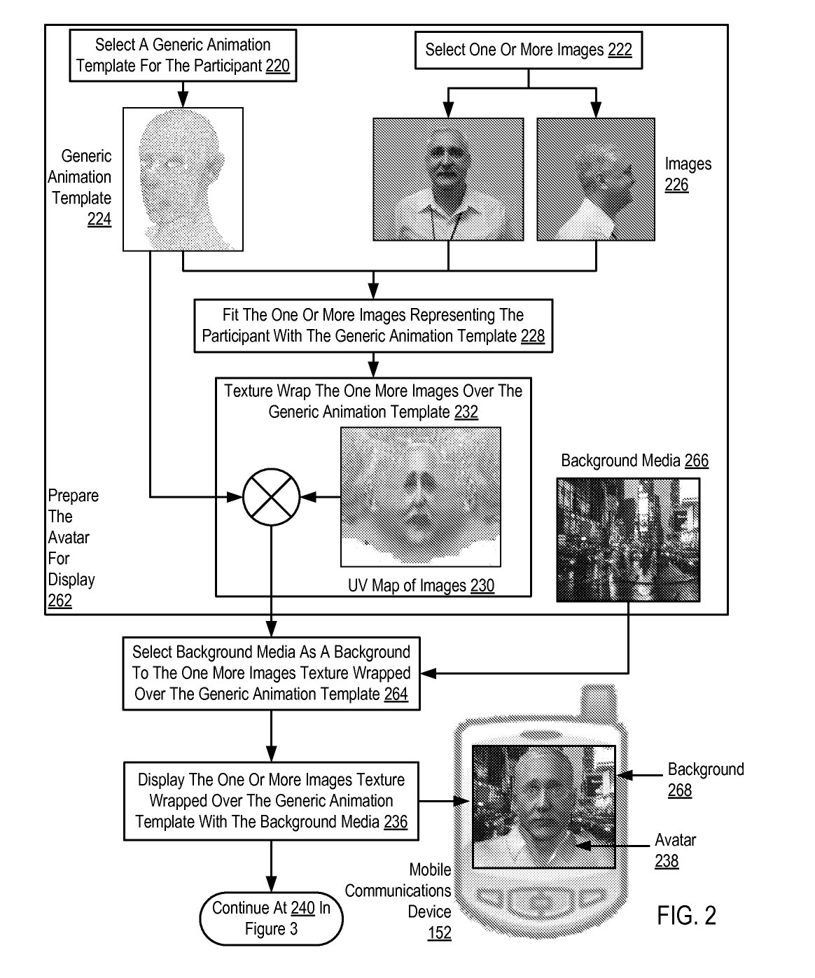

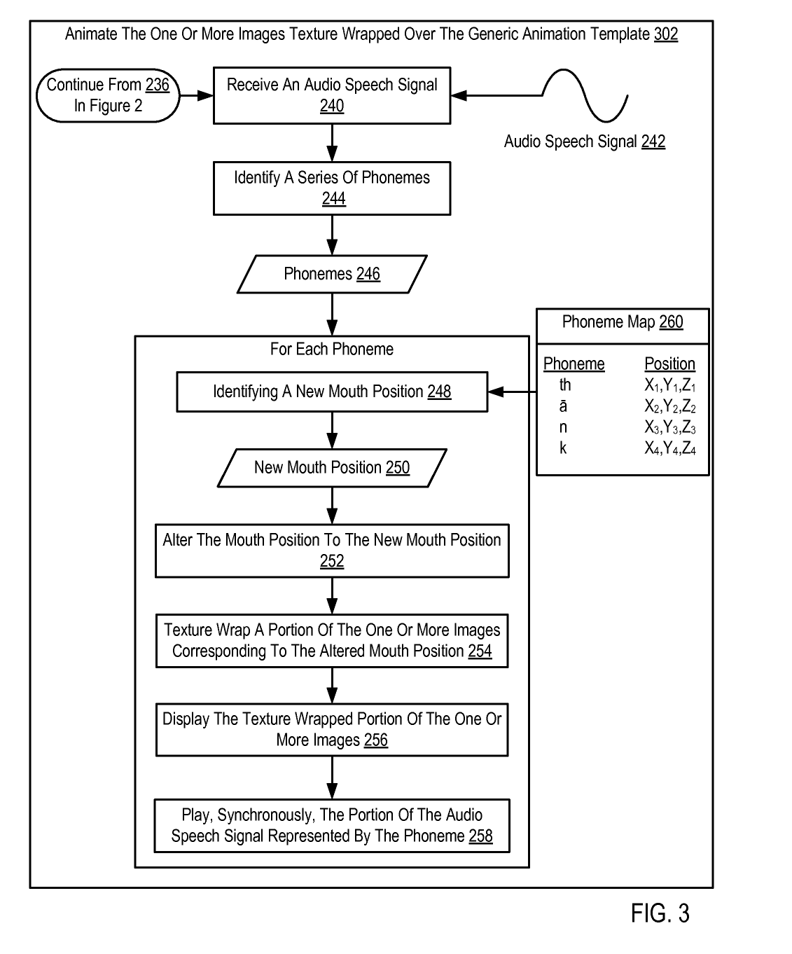

For further explanation, FIG. 2 and FIG. 3 set forth a flow chart illustrating an exemplary method for animating speech of an avatar representing a participant in a mobile communication according to embodiments of the present invention. The method of FIG. 2 sets forth a portion of a flow chart illustrating an exemplary method for animating speech of an avatar representing a participant in a mobile communication according to embodiments of the present invention that includes selecting (222), by an animation module installed on the mobile communications device (152) from data storage, one or more images (226) to represent the participant. Selecting (222) one or more images (226) to represent the participant may be carried out by identifying the participant in the mobile communication and selecting the one or more images in dependence upon the identified participant. Identifying the participant may be carried out by identifying the phone number from which the participant is calling. In many typical mobile communications devices, a profile associated with a particular participant may be stored. The profile may include one or more of the participant's phone numbers, the participant's email address, one or more images of the participant, and so on as will occur to those of skill in the art. Upon receiving a call from the participant, the animation module may identify the participant using the participant's phone number, match the phone number to a stored profile for the participant, and match the profile to one or more images to represent the participant.

The method of FIG. 2 also includes selecting (220), by the animation module from data storage, a generic animation template (224) for the participant. A generic animation template is a generalized representation of a participant used as a template for the avatar representing the participant. A generic animation template may be a three-dimensional model of a genderless human's head or bust. The three-dimensional model may also be a data structure containing information defining the shape of the head. The three-dimensional model may be rendered for display according to one of a number of different modeling processing, including for example, a polygonal modeling process or a Non-uniform, rational basis spline (‘NURBS’) modeling process. Polygonal modeling is a modeling process in which an object is represented by approximating the objects' surfaces using a number of polygons. In such an implementation, the three-dimensional model may be implemented as a data structure containing information describing the vertices of a number of polygons. NURBS modeling is a modeling process in which an object is represented by a number of curves. In such an implementation, the three-dimensional model may be implemented as a data structure containing information describing curves that represent the head, including a number of control points and weights associated with each point. A model, according to either implementation, may be displayed as wire-frame model, a number of lines specifying the outer edges of an object. In the method FIG. 2, for example, the generic animation template (224) of FIG. 2 is shown as a wire-frame model for clarity.

In the example of FIG. 2 the generic animation template (224) has a mouth and the mouth is characterized by a mouth position. The mouth of the generic animation template may be defined according to the modeling processes described above. The mouth position of the generic animation template is the default position of the mouth. That is, when the avatar is not in animation, the mouth will be rendered in the default position.

The method of FIG. 2 also includes fitting (228), by the animation module, the one or more images (226) representing the participant with the generic animation template (224). Fitting (228) the one or more images (226) with the generic animation template (224) may be carried out by resizing the one or more images to conform with the size of the generic animation template, identifying specific facial features of the one or more images, aligning the specific facial features with corresponding facial features of the generic animation template, and reshaping the generic animation template to conform with the one or more images. Reshaping the generic animation template may be carried out by redefining the vertices of polygons or redefining control points and weights of curves depending upon the implementation of the modeling process.

The method of FIG. 2 also includes texture wrapping (232), by the animation module, the one or more images (226) representing the participant over the generic animation template (224). Texture wrapping (232) the one or more images (226) over the generic animation template (224) may be carried out by creating a UV map (230) of the one or more images (226) and associating portions of the UV map with corresponding vertices or control points of the generic animation template. For example, the mouth portion of the UV map is associated with the mouth portion of the generic animation template, the nose portion of the UV map is associated with the nose portion of the generic animation template, and so on. A UV map is a two dimensional image representing a three dimensional object. A UV map is so named, “UV,” because in contrast to the X, Y, and Z coordinates that define the object in three dimensional space, the UV map defines the three dimensional object in only two dimensions, the U and V dimensions.

The method of FIG. 2 also includes selecting (264), by the animation module from storage, background media (266) as a background to the one or more images (226) texture wrapped (232) over the generic animation template (224). As mentioned above, the background media (266) may be any type of media capable of being displayed behind an avatar, including for example a digital image, a digital video, an animated graphic, and the like. In the example of FIG. 2, the background media (266) is a digital image of Times Square in New York City.

The method of FIG. 2 also includes displaying (236), by the animation module, the one or more images (226) texture wrapped (232) over the generic animation template (224) with the background media (226) as the background (268) to the one or more images (226) texture wrapped (232) over the generic animation template (224). Displaying (236) the one or more images texture wrapped over the generic animation template may be carried out by rendering on the display of the mobile communications device the one or more images texture wrapped over the generic animation template as the avatar for the participant.

Displaying (236) the background media (226) as the background (268) to the one or more images (226) texture wrapped (232) over the generic animation template (224) may include replacing a default background comprising a single color with the background media. That is, the animation module may employ a technique called Chroma key to replace the default background with the background media. Chroma key is a technique for blending two images in which a color or small color range from one image is replaced by another image. Such a technique is often referred to as greenscreen or bluescreen and is employed in weather forecast broadcasts.

After displaying (236) the one or more images texture wrapped over the generic animation template the method of FIG. 2 continues at the method of FIG. 3. The method of FIG. 3 sets forth a flow chart illustrating additional steps of animating speech of an avatar representing a participant in a mobile communication according to embodiments of the present invention. The method of FIG. 3 includes receiving (240), by the animation module, an audio speech signal (242) derived from the mobile communication of the participant. Receiving (240) an audio speech signal (242) may be carried out by receiving text from the participant's mobile communications device and creating synthesized speech from the text or, in the alternative, receiving audio from the participant's mobile communications device.

The method of FIG. 3 also includes identifying (244), by the animation module from the audio speech signal (242), a series of phonemes (246), each phoneme representing a portion of the audio speech signal. Identifying (244) a series of phonemes (246) may be carried out by using an Automatic Speech Recognition (‘ASR’) engine as described above.

For each phoneme (246) identified (244) from the audio speech signal (242), the method of FIG. 3 continues by: identifying (248) a new mouth position (250) for the mouth of the generic animation template (224 on FIG. 2); altering (252) the mouth position of the mouth of the generic animation template to the new mouth position (250); texture wrapping (254) a portion of the one or more images (226 on FIG. 2) corresponding to the altered mouth position of the mouth of the generic animation template (224 on FIG. 2); displaying (256) the texture wrapped portion of the one or more images corresponding to the altered mouth position of the mouth of the generic animation template; and playing (258), synchronously with the displayed texture wrapped portion of the one or more images, the portion of the audio speech signal represented by the phoneme.

Identifying (248) a new mouth position (250) for the mouth of the generic animation template (224 on FIG. 2) may be carried out by locating in a phoneme map (260) a new mouth position associated with an identified phoneme (246). In the method FIG. 3, for example, the phoneme map (260) includes five phonemes that make up the word “thank.” Each phoneme is associated with a position. The positions in the phoneme map (260) of FIG. 3 are shown for clarity as an X, Y, Z coordinate, but readers of skill in the art will recognize that the position associated with a phoneme may be a set of coordinates defining a group of polygons or a group of control points and weights.

Altering (252) the mouth position of the mouth of the generic animation template to the new mouth position (250) may be carried out by redefining the vertices or control points and weights of the portion of the generic animation template corresponding to the mouth to the vertices or control points and weights identified from the phoneme map. Texture wrapping (254) a portion of the one or more images (226 on FIG. 2) corresponding to the altered mouth position of the mouth of the generic animation template (224 on FIG. 2) may be carried out by associating the mouth portion of the UV map (230 on FIG. 2) with the new corresponding vertices or control points of the altered generic animation template.

Displaying (256) the texture wrapped portion of the one or more images corresponding to the altered mouth position of the mouth of the generic animation template may be carried out by rendering the mouth portion of the one or more images texture wrapped over the altered generic animation template with the previously displayed one or more images texture wrapped over the generic animation template. That is, only the altered mouth portion of the avatar is rendered for display, while the remaining portion of the avatar is a static display. In this way, in contrast to an entire re-wrapping and re-rendering of the avatar, the texture wrapping and display of the avatar is lightweight.

Playing (258), synchronously with the displayed texture wrapped portion of the one or more images, the portion of the audio speech signal represented by the phoneme may be carried out by delaying the playing of the portion of audio speech to coincide with the display of the texture wrapped portion of the one or more images corresponding to the altered mouth position of the mouth of the generic animation template. In this way, the speech of an avatar will be animated such that the avatar appears to be speaking synchronously with the audio of the speech.

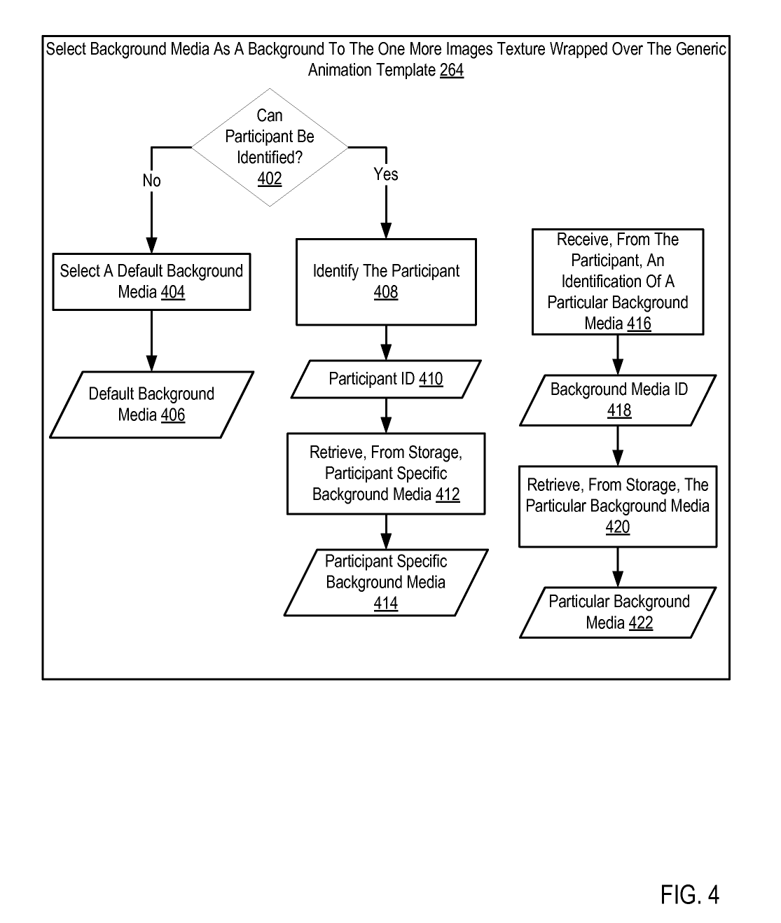

For further explanation, FIG. 4 sets forth a flow chart illustrating an exemplary method for selecting (264) background media as a background to the one or more images texture wrapped over the generic animation template when animating speech of an avatar representing a participant in a mobile communication according to embodiments of the present invention.

The method of FIG. 4 sets forth various way in which background media may be selected. In the method of FIG. 4, for example, selecting (264) background media may include determining (402) whether the participant can be identified. Determining (402) whether the participant can be identified may be carried out in various ways, including for example, determining whether the participant's caller ID, telephone number, mobile communications device identifier, name, screen name, or the like is identifiable. In the case of a telephone number, the animation module, may for example determine if the participant's telephone number is included in a list of contacts stored on the mobile communications device.

If the participant cannot be identified, selecting background media (264) continues by selecting (404) a default background media (406). That is, a manufacturer of a mobile communications device may provide one or more default background digital images, digital videos, or the like, to be selected, or used, as backgrounds for avatars of participants that cannot immediately be identified. If, however, the participant can be identified, selecting (264) background media may be carried out by identifying the participant (308), retrieving (412), from storage in dependence upon the participant's identification (410), participant specific background media (414).

In the method of FIG. 4, selecting (264) may also be carried out by receiving (416), from the participant, an identification (418) of a particular background media and retrieving (420), from storage in dependence upon the identification (418), the particular background media (422). Receiving an identification of a particular background media from the participant may be carried out in various ways including, receiving, via (‘Small Message System’) text, email, or other form of communications, a storage location in the form of a Uniform Resource Locator (‘URL’). Receiving an identification of a particular background media form a participant may also be carried out by receiving a copy of the particular background media itself, prior to, or as part of initiating a communications session between the participant and the mobile communications device. Such a copy of the particular background media may be sent to the mobile communications device in various ways: by sending the media as part of a handshake operation initiating a data communications session in accordance with a data communications protocol, by sending the media to an email address designated for receipt of such media, and by sending the media to the communications device via a Multimedia Message System (‘MMS’) message, and in other ways as may occur to readers of skill in the art. In this way, the participant, rather than the recipient or mobile communications device, controls, to some extent, the selection of background media to be displayed as a background to the participant's avatar.

In addition to displaying a background image behind the animated avatar, embodiments of the present invention may also include displaying foreground images in front of the animated avatar. Text and symbol overlays, for example, may be displayed in front of the avatar to augment the speech of the animated avatar.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. Java is a trademark of Sun Microsystems, Inc. in the United States, other countries, or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer implemented method of animating speech of an avatar representing a participant in a mobile communication, the avatar displayed on a display screen of a mobile communications device, the method comprising:
preparing for display, by the mobile communications device, the avatar including: selecting, from data storage, one or more images to represent the participant, selecting, from data storage, a generic animation template for the participant, the generic animation template having a mouth, the mouth characterized by a mouth position, fitting the one or more images representing the participant with the generic animation template, and texture wrapping the one or more images representing the participant over the generic animation template;
selecting, by the mobile communications device from storage, background media as a background to the one or more images texture wrapped over the generic animation template;
displaying, by the mobile communications device, the one or more images texture wrapped over the generic animation template with the background media as the background to the one or more images texture wrapped over the generic animation template; and
animating, by the mobile communications device, the one or more images texture wrapped over the generic animation template including: receiving an audio speech signal derived from the mobile communication of the participant, identifying, from the audio speech signal, a series of phonemes, each phoneme representing a portion of the audio speech signal, and for each phoneme: identifying a next mouth position for the mouth of the generic animation template, altering the mouth position of the mouth of the generic animation template to the next mouth position, texture wrapping a portion of the one or more images corresponding to the altered mouth position of the mouth of the generic animation template, displaying the texture wrapped portion of the one or more images corresponding to the altered mouth position of the mouth of the generic animation template and playing, synchronously with the displayed texture wrapped portion of the one or more images, the portion of the audio speech signal represented by the phoneme.

2. The method of claim 1 wherein selecting background media further comprises:
identifying the participant; and
retrieving, from storage, participant specific background media.

3. The method of claim 2 wherein selecting background media further comprises selecting a default background media if the participant cannot be identified.

4. The method of claim 1 wherein selecting background media further comprises:
receiving, from the participant, an identification of a particular background media; and
retrieving, from storage in dependence upon the identification, the particular background media.

5. The method of claim 1 wherein displaying the one or more images texture wrapped over the generic animation template with the background media
further comprises replacing a default background comprising a single color with the background media.

6. The method of claim 1 wherein selecting background media further comprises selecting one of: a digital image or digital video.

7. A computer system for animating speech of an avatar representing a participant in a mobile communication, the avatar displayed on a display screen of the mobile communications device, the computer system comprising:
a computer processor, a computer readable memory and a computer readable storage medium;
first program instructions to prepare for display, by the mobile communications device, the avatar including: selecting, from data storage, one or more images to represent the participant, selecting, from data storage, a generic animation template for the participant, the generic animation template having a mouth, the mouth characterized by a mouth position, fitting the one or more images representing the participant with the generic animation template, and texture wrapping the one or more images representing the participant over the generic animation template;
second program instructions to select, by the mobile communications device from storage, background media as a background to the one or more images texture wrapped over the generic animation template;
third program instructions to display, by the mobile communications device, the one or more images texture wrapped over the generic animation template with the background media as the background to the one or more images texture wrapped over the generic animation template; and
fourth program instructions to animate, by the mobile communications device, the one or more images texture wrapped over the generic animation template including: receiving an audio speech signal derived from the mobile communication of the participant, identifying, from the audio speech signal, a series of phonemes, each phoneme representing a portion of the audio speech signal, and for each phoneme: identifying a next mouth position for the mouth of the generic animation template, altering the mouth position of the mouth of the generic animation template to the next mouth position, texture wrapping a portion of the one or more images corresponding to the altered mouth position of the mouth of the generic animation template, displaying the texture wrapped portion of the one or more images corresponding to the altered mouth position of the mouth of the generic animation template and playing, synchronously with the displayed texture wrapped portion of the one or more images, the portion of the audio speech signal represented by the phoneme;
wherein the first, second, third, and fourth program instructions are stored on the computer readable storage medium for execution by the computer processor via the computer readable memory.

8. The computer system of claim 7 wherein selecting background media further comprises:
identifying the participant; and
retrieving, from storage, participant specific background media.

9. The computer system of claim 8 wherein selecting background media further comprises selecting a default background media if the participant cannot be identified.

10. The computer system of claim 7 wherein selecting background media further comprises:
receiving, from the participant, an identification of a particular background media; and
retrieving, from storage in dependence upon the identification, the particular background media.

11. The computer system of claim 7 wherein displaying the one or more images texture wrapped over the generic animation template with the background media further comprises replacing a default background comprising a single color with the background media.

12. The computer system of claim 7 wherein selecting background media further comprises selecting one of: a digital image or digital video.

13. A computer program product for animating speech of an avatar representing a participant in a mobile communication, the avatar displayed on a display screen of a mobile communications device, the computer program product comprising:
a computer readable storage medium;
first program instructions to prepare for display, by the mobile communications device, the avatar including: selecting, from data storage, one or more images to represent the participant, selecting, from data storage, a generic animation template for the participant, the generic animation template having a mouth, the mouth characterized by a mouth position, fitting the one or more images representing the participant with the generic animation template, and texture wrapping the one or more images representing the participant over the generic animation template;
second program instructions to select, by mobile communications device from storage, background media as a background to the one or more images texture wrapped over the generic animation template;
third program instructions to display, by the mobile communications device, the one or more images texture wrapped over the generic animation template with the background media as the background to the one or more images texture wrapped over the generic animation template; and
fourth program instructions to animate, by the mobile communications device, the one or more images texture wrapped over the generic animation template including: receiving an audio speech signal derived from the mobile communication of the participant, identifying, from the audio speech signal, a series of phonemes, each phoneme representing a portion of the audio speech signal, and for each phoneme: identifying a next mouth position for the mouth of the generic animation template, altering the mouth position of the mouth of the generic animation template to the next mouth position, texture wrapping a portion of the one or more images corresponding to the altered mouth position of the mouth of the generic animation template, displaying the texture wrapped portion of the one or more images corresponding to the altered mouth position of the mouth of the generic animation template and playing, synchronously with the displayed texture wrapped portion of the one or more images, the portion of the audio speech signal represented by the phoneme;
wherein the first, second, third, and fourth program instructions are stored on the computer readable storage medium.

14. The computer program product of claim 13 wherein selecting background media further comprises:
identifying the participant; and
retrieving, from storage, participant specific background media.

15. The computer program product of claim 14 wherein selecting background media further comprises selecting a default background media if the participant cannot be identified.

16. The computer program product of claim 13 wherein selecting background media further comprises:
receiving, from the participant, an identification of a particular background media; and
retrieving, from storage in dependence upon the identification, the particular
background media.

17. The computer program product of claim 13 wherein displaying the one or more images texture wrapped over the generic animation template with the background media further comprises replacing a default background comprising a single color with the background media.

18. The computer program product of claim 13 wherein selecting background media further comprises selecting one of: a digital image or digital video.

19. The computer program product of claim 13 wherein the storage medium comprises a recordable medium.

20. The computer program product of claim 13 wherein the storage medium comprises a transmission medium.
